(19) United States
(12) Patent Application Publication
(10) Pub. No.: US 2011/0321141 A1
(43) Pub. Date: Dec. 29, 2011

(54) NETWORK DEVICES WITH LOG-ON INTERFACES

(76) Inventors: Hongning ZENG, Beijing (CN); Shaolan WANG, Beijing (CN); Zhengwei GAO, Beijing (CN); Kun PEI, Beijing (CN); Jianjun LI, Beijing (CN); Zhibin HUA, Shenzhen (CN)

(21) Appl. No.: 12/839,147

(22) Filed: Jul. 19, 2010

(30) Foreign Application Priority Data
Jun. 29, 2010 (CN) 201010215936.8

(51) Int. Cl. G06F 21/20

(52) U.S. Cl. 726/5

(57) ABSTRACT

A credential provider component receives predetermined identity information (IDINF) from a portable device and controls an information database to provide a predetermined credential if the predetermined IDINF matches content in the information database. A log-on component allows the portable device to log on to a network device using the predetermined credential if the predetermined credential is valid.

### CROSS REFERENCE TO RELATED APPLICATION

This Application claims priority to the Chinese patent application, Application Number 201010215936.8, filed on Jun. 29, 2010, which is hereby incorporated by reference.

### BACKGROUND

Computer systems usually include log-on components and lock/unlock components to protect the computer systems from being accessed by unauthorized users. For example, when a computer system is powered on, a user needs to provide an authorized credential to log on to the computer system. The user can access and/or control applications in the computer system only when the user logs on to the computer system successfully. A conventional method to provide the credential to the computer system includes inputting a user name and a password in a log-on window on a screen of the computer system.

During the time when the computer system is logged on, if the computer system receives no instruction from the user for a predetermined time, the lock/unlock component may lock the computer system automatically. In order to access and/or control the applications in the computer system, the user needs to provide the authorized credential again, e.g., input the user name and the password, so as to unlock the computer system. In other words, each time the computer system is locked, the user may need to input the user name and the password. Having to repeatedly input the user name and password may inconvenience the user. In addition, since the user may need to input the user name and the password repeatedly, the possibility for an unauthorized user to get (or steal) the user name and the password successfully may be increased.

### SUMMARY

In one embodiment, computer-executable components stored on a non-transitory computer-readable storage medium include a credential provider component and a log-on component. The credential provider component can receive predetermined identity information (IDINF) from a portable device and control an information database to provide a predetermined credential if the predetermined IDINF matches content in the information database. The log-on component can allow the portable device to log on to a network device using the predetermined credential if the predetermined credential is valid.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 illustrates a block diagram of an example of a network, in accordance with one embodiment of the present invention.

FIG. 2 illustrates a flowchart of an example of a log-on process performed by a network device, in accordance with one embodiment of the present invention.

FIG. 3 illustrates a block diagram of an example of a network, in accordance with one embodiment of the present invention.

FIG. 4 illustrates a flowchart of an example of an enrollment process performed by a network device, in accordance with one embodiment of the present invention.

FIG. 5 illustrates a flowchart of an example of an automatic locking/unlocking process performed by a network device, in accordance with one embodiment of the present invention.

FIG. 6 illustrates a block diagram of an example of a network, in accordance with one embodiment of the present invention.

FIG. 7 illustrates a flowchart of examples of operations performed by a network device, in accordance with one embodiment of the present invention.

FIG. 8 illustrates a block diagram of an example of a computer system for enabling website logon through facial authentication, in accordance with one embodiment of the present invention.

FIG. 9 illustrates a flowchart of an example of a method for capturing the user logon credential, in accordance with one embodiment of the present invention.

FIG. 10 illustrates a flowchart of an example of a method for automatically filling in the user logon credential, in accordance with one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Embodiments described herein may be discussed in the general context of computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “receiving,” “controlling,” “allowing,” “detecting,” “generating,” “providing,” “authenticating,” “searching,” “obtaining” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

By way of example, and not limitation, computer-usable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information.

Communication media can embody computer-readable instructions, data structures, program modules or other data and includes any information delivery media. By way of example, and not limitation, communication media includes wired media such as a wired network or direct-wired connection, and wireless media such as acoustic, radio frequency (RF), infrared and other wireless media. Combinations of any of the above should also be included within the scope of computer-readable media.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

In one embodiment, the present invention provides a network that includes a portable device and a network device. The portable device includes predetermined identity information for identifying the portable device. The identity information is associated with a predetermined credential. The network device can receive the predetermined identity information from the portable device and authenticate the predetermined identity information. If the authentication result indicates that the predetermined identity information is valid (or authorized), the network device assists the portable device in logging on to the network device using the predetermined credential. Otherwise, the network device discards the predetermined identity information.

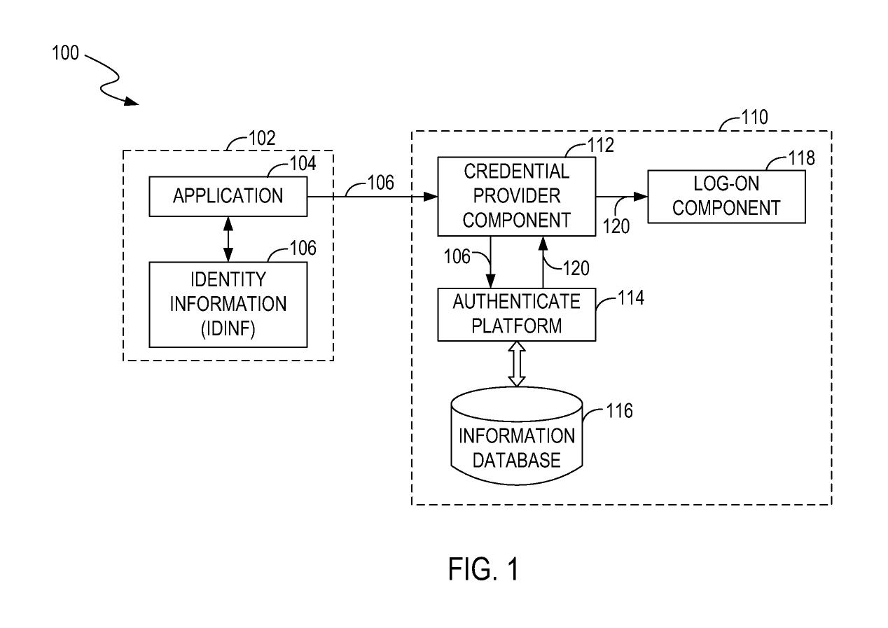

FIG. 1 illustrates a block diagram of an example of a network 100, in accordance with one embodiment of the present invention. The network 100 includes a portable device 102 (e.g., a mobile phone, a personal digital assistant (PDA) device, a portable media player, an earphone) and a network device 110 (e.g., a computer, a router). The portable device 102 can include one or more hardware modules to store predetermined identity information 106 (hereinafter, IDINF 106) and a software program such as an application program 104. The network device 110 can include a computer-readable medium to store an information database 116 and program modules such as a credential provider component 112 and a log-on component 118. The network device 110 can further include a processor (not shown in FIG. 1) to execute the program modules.

In one embodiment, the IDINF 106 is used to identify the portable device 102. In one embodiment, the predetermined IDINF 106 includes a serial number associated with an identity module in the portable device 102. For example, the portable device 102 can be a mobile phone that includes a subscriber identity module (SIM) card plugged therein. The SIM card contains a serial number, e.g., an international mobile subscriber identity (IMSI) number, associated with the SIM card or a corresponding mobile phone user. In another embodiment, the predetermined IDINF 106 includes a network address for a communication module in the portable device 102. For example, the predetermined IDINF 106 includes a BLUETOOTH address, e.g., a globally unique address, for a BLUETOOTH communication module in the portable device 102, e.g., a mobile phone, a PDA, a portable media player, an earphone, etc. For another example, the predetermined IDINF 106 includes a media access control (MAC) address, e.g., a globally unique address, of a wired communication module or a wireless communication module in the portable device 102. In yet another embodiment, the predetermined IDINF 106 includes a serial number/code or an identity number/code that identifies a module, an integrated circuit, an electronic chip, or the like in the portable device 102.

In one embodiment, the application program 104 can communicate with the network device 110. For example, the application program 104 can generate a data packet that contains the predetermined IDINF 106 and send/transmit the data packet to the network device 110 via a channel, e.g., a BLUETOOTH channel, a WI-FI channel, a general packet radio service (GPRS) channel, a cable, etc. In one embodiment, after receiving the predetermined IDINF 106, the network device 110 authenticates the predetermined IDINF 106 and generates an authentication result. If the authentication result indicates that the predetermined IDINF 106 is invalid (or unauthorized), the network device 110 may discard the predetermined IDINF 106. Otherwise, the network device 110 assists the portable device 102 in logging on to the network device 110. If the portable device 102 logs on to the network device 110 successfully, the portable device 102 can communicate with the network device 110, e.g., it can access applications in the network device 110. Otherwise, the network device 110 may discard the predetermined IDINF 106.

In one embodiment, the network device 110 includes an operating system (not shown in FIG. 1) that supports operations performed by the credential provider component 112 and the log-on component 118. The log-on component 118 can receive a credential, e.g., a user name, a password, data representative of characteristics of a face, data representative of characteristics of a fingerprint, etc., from a log-on interface (not shown in FIG. 1). For example, a user can input the user name and the password via a log-on window, e.g., a log-on interface, displayed on a screen of the network device 110. The log-on component 118 may also receive the credential by using face-recognition software to capture the characteristics of the face of the user. The log-on component 118 may also receive the credential by using fingerprint-recognition software to capture the characteristics of a fingerprint of the user.

Alternatively, the log-on component 118 can receive a credential for the user from the credential provider component 112. More specifically, the network device 110 includes a communication interface (not shown in FIG. 1), e.g., a BLUETOOTH interface, coupled to the processor. The communication interface can receive a predetermined IDINF 106 from a portable device 102, e.g., a device that belongs to the user, and transfer the predetermined IDINF to the credential provider component 112. The credential provider component 112, which may be executed by the processor, can authenticate the predetermined IDINF 106 and automatically provide a predetermined credential 120 for the user to the log-on component 118 according to the authentication result. The log-on component 118, which may be executed by the processor, can further authenticate the predetermined credential 120, e.g., it can search for the predetermined credential 120 in a predefined credential list (not shown in FIG. 1). If the predetermined credential 120 is valid, e.g., it is found in the predefined credential list, the log-on component 118 allows the user, e.g., the portable device 102, to log on to the network device 110 using the predetermined credential 120. Otherwise, the log-on component 118 may discard the predetermined credential 120.

Advantageously, the user can select to log on to the network device 110 automatically, such that the user does not need to input the credential such as the user name and the password every time the user needs to log on to the network device 110. Thus, the user can use the network device 110 more conveniently. In addition, the user can keep the user name and the password more safely.

In one embodiment, the information database 116 includes a set of data pairs. Each data pair of the set of data pairs includes a pre-stored credential and a pre-stored IDINF associated with the pre-stored credential. After receiving a predetermined IDINF 106 from the portable device 102, the network device 110 can authenticate the predetermined IDINF 106 on an authentication platform 114 based on the information database 116 and can generate an authentication result. For example, the network device 110 authenticates the predetermined IDINF 106 by searching for the predetermined IDINF 106 in the set of data pairs stored in the information database 116. If the predetermined IDINF 106 is found in the information database 116, the authentication result indicates that the predetermined IDINF 106 is valid. In other words, the pair that includes the predetermined IDINF 106 and a predetermined credential 120 associated with the predetermined IDINF 106 can be found in the information database 116. The credential provider component 112 controls the information database 116 to provide the predetermined credential 120 to the log-on component 118 when the predetermined IDINF 106 is found in the information database 116. In one embodiment, the credential provider component 112 obtains the predetermined credential 120 from the information database 116 and transfers the predetermined credential 120 to the log-on component 118. In another embodiment, the log-on component 118 may obtain the predetermined credential 120 from the information database 116 directly. If the predetermined IDINF 106 is not found in the information database 116, the authentication result indicates that the predetermined IDINF 106 is invalid. The network device 110 may then discard the predetermined IDINF 106.

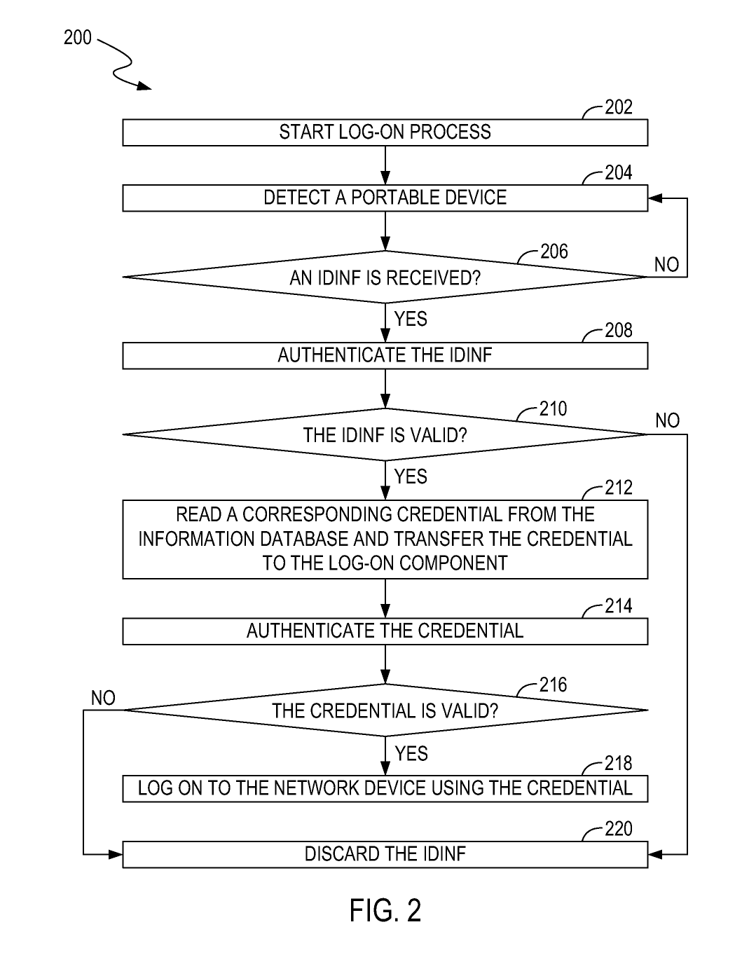

FIG. 2 illustrates a flowchart 200 of an example of a log-on process performed by the network device 110, in accordance with one embodiment of the present invention. In one embodiment, the flowchart 200 is implemented as computer-executable instructions stored in a non-transitory computer-readable medium. FIG. 2 is described in combination with FIG. 1.

At step 202, the network device 110 starts a log-on process (or an automatic log-on process). At step 204, the network device 110 detects a portable device, e.g., a mobile phone, a PDA device, a portable media player, an earphone, etc. For example, at step 206, the network device 110 detects whether an IDINF 106 is received.

If the network device 110 receives an IDINF 106, the network device 110 performs step 208 to authenticate the IDINF 106, e.g., to search for the IDINF 106 in the information database 116. At step 210, if the IDINF 106 is invalid, e.g., the IDINF 106 is not found in the information database 116, the network device 110 performs step 220 to discard the IDINF 106. If the IDINF 106 is valid, e.g., the IDINF 106 is found in the information database 116, the flowchart 200 goes to step 212.

At step 212, the credential provider component 112 reads a corresponding credential 120 from the information database 116 and transfers the credential 120 to the log-on component 118. At step 214, the log-on component 118 authenticates the credential 120, e.g., it searches for the credential 120 in the predefined credential list. At step 216, if the credential 120 is invalid, e.g., the credential 120 is not found in the predefined credential list, the network device 110 performs step 220 to discard the IDINF 106 and the credential 120. If the credential 120 is valid, e.g., the credential 120 is found in the predefined credential list, the flowchart 200 goes to step 218. At step 218, the log-on component 118 assists the portable device 102 in logging on to the network device 110 using the credential 120.

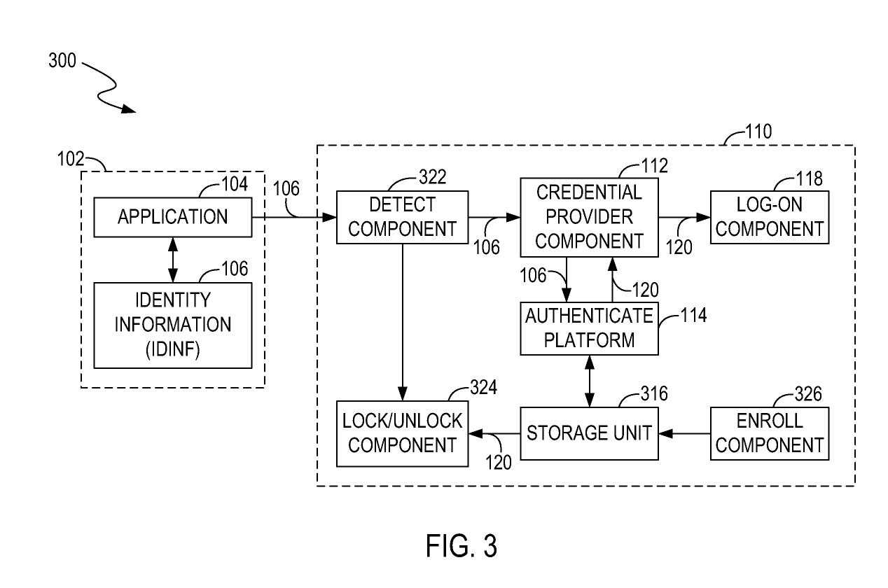

FIG. 3 illustrates a block diagram of an example of a network 300, in accordance with one embodiment of the present invention. Elements that are labeled the same as in FIG. 1 have similar functions. As shown in FIG. 3, the network device 110 further includes program modules such as a detect component 322, a lock/unlock component 324, and an enroll component 326. These program modules can be stored in a computer-readable medium. The network device 110 further includes a storage unit 316 that can be separate from the computer-readable medium or implemented in the computer-readable medium. The storage unit 316 can be used to store the information database 116 shown in FIG. 1.

The detect component 322 can be used to receive a data packet from the portable device 102. The detect component 322 can also detect a status of the portable device 102. For example, the detect component 322 detects whether the portable device 102 is within a specified range, e.g., whether the distance from the portable device 102 to the network device 110 is less than a specified length. More specifically, the portable device 102 includes a wireless communication module, e.g., a BLUETOOTH communication module, for exchanging data over short distances. In one embodiment, if the wireless communication module, e.g., a BLUETOOTH communication module, is enabled, and the distance between the portable device 102 and the network device 110 is less than the specified length, the network device 110 may be able to receive a data pack that includes the IDINF 106, e.g., the BLUETOOTH address, of the portable device 102. Thus, the portable device 102 is considered to be within the specified range. If the wireless communication module is disabled or the distance between the portable device 102 and the network device 110 is greater than the specified length, the network device 110 may not be able to receive the data pack that includes the IDINF 106 of the portable device 102. Thus, the portable device 102 is considered to be outside the specified range.

The enroll component 326 can be used to enroll a credential and an IDINF in the information database 116 (shown in FIG. 1), e.g., write the credential and the IDINF into the storage unit 316. More specifically, during an enrolling process, when the network device 110 receives an IDINF 106 from the portable device 102, a user provides a credential 120 to the enroll component 326. For example, the user inputs a user name and a password into an enroll window on a screen of the network device 110. For another example, face-recognition software is used to capture the characteristics of the face of the user. For yet another example, fingerprint-recognition software is used to capture the characteristics of a fingerprint of the user. As such, the enroll component 326 writes the IDINF 106 and the credential 120 into the storage unit 316. Multiple credentials and corresponding IDINFs can be enrolled in the information database 116 in a similar manner. In one embodiment, in the information database 116, each IDINF corresponds to one credential. However, each credential may correspond to one or more IDINF. In other words, one or more IDINF may share the same credential.

The storage unit 316 can store the information database 116, e.g., it stores a set of data pairs that includes multiple credentials and corresponding IDINFs.

The storage unit 316 can also store a temporary IDINF. More specifically, when the network device 110 receives an IDINF 106 from the portable device 102, the IDINF 106 can be stored in the storage unit 316 temporarily. The lock/unlock component 324 can perform a locking/unlocking process based on the temporarily stored IDINF 106.

More specifically, in one embodiment, during the time when the portable device 102 is logged on to the network device 110, the detect component 322 detects a status of the portable device 102. If the portable device 102 is powered off, or if the portable device 102 is moved away so that it is outside a specified range, the detect component 322 may not receive the IDINF 106 from the portable device 102. Thus, the detect component 322 generates a lock signal to the lock/unlock component 324. Accordingly, the lock/unlock component 324 performs a locking process to lock the network device 110. During the time when the network device 110 is locked, the detect component 322 continues to detect the status of the portable device 102. If the detect component 322 receives an IDINF that is the same as the IDINF 106 temporarily stored in the storage unit 316, the portable device 102 is considered to be within a specified range and, in response, the detect component 322 generates an unlock signal to the lock/unlock component 324. Accordingly, the lock/unlock component 324 performs an unlocking process to unlock the network device 110 using the credential 120. However, if the detect component 322 receives an IDINF that is different from the IDINF 106 temporarily stored in the storage unit 316, that may indicate a different portable device is within the specified range. The network device 110 may discard the presently received IDINF and continue to detect the status of the portable device 102.

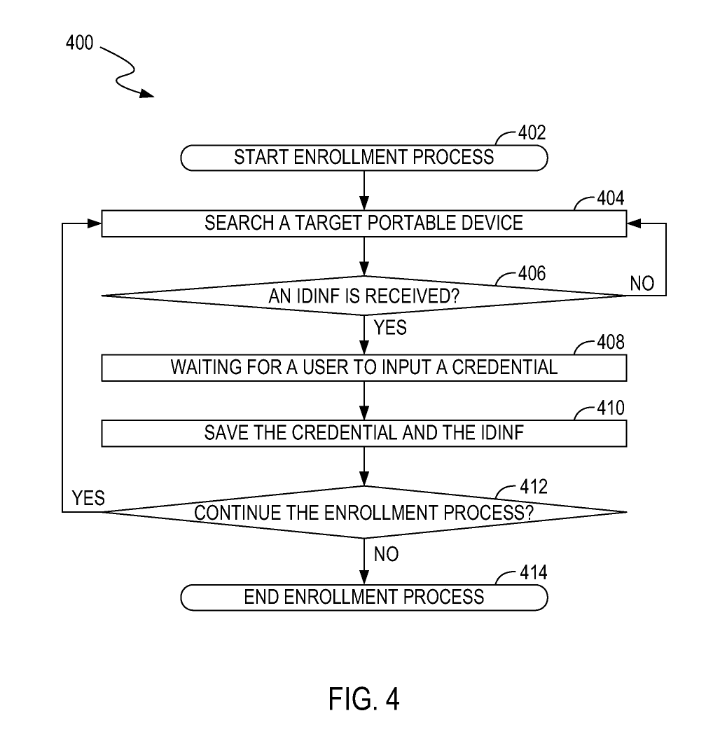

FIG. 4 illustrates a flowchart 400 of an example of an enrollment process performed by the network device 110, in accordance with one embodiment of the present invention. In one embodiment, the flowchart 400 is implemented as computer-executable instructions stored in a non-transitory computer-readable medium. FIG. 4 is described in combination with FIG. 1 and FIG. 3.

At step 402, the network device 110 starts an enrollment process. At step 404, the network device 110 searches a target portable device 102. For example, at step 406, the detect component 322 detects whether an IDINF 106 is received. If the network device 110 receives the IDINF 106 from the target portable device 102, the network device 110 performs step 408, waiting for a user to input a credential 120, e.g., a user name, a password, data representative of characteristics of a face, data representative of characteristics of a fingerprint, etc. When the enroll component 326 receives the credential 120, the network device 110 performs step 410 to save the credential 120 and the IDINF 106, e.g., write the credential 120 and the IDINF 106 into the storage unit 316.

At step 412, the network device 110 can receive an instruction/command from the user. If the user instructs the network device 110 to continue to perform the enrollment process, the flowchart 400 goes to step 404. Otherwise, the network device 110 performs step 414 to end the enrollment process.

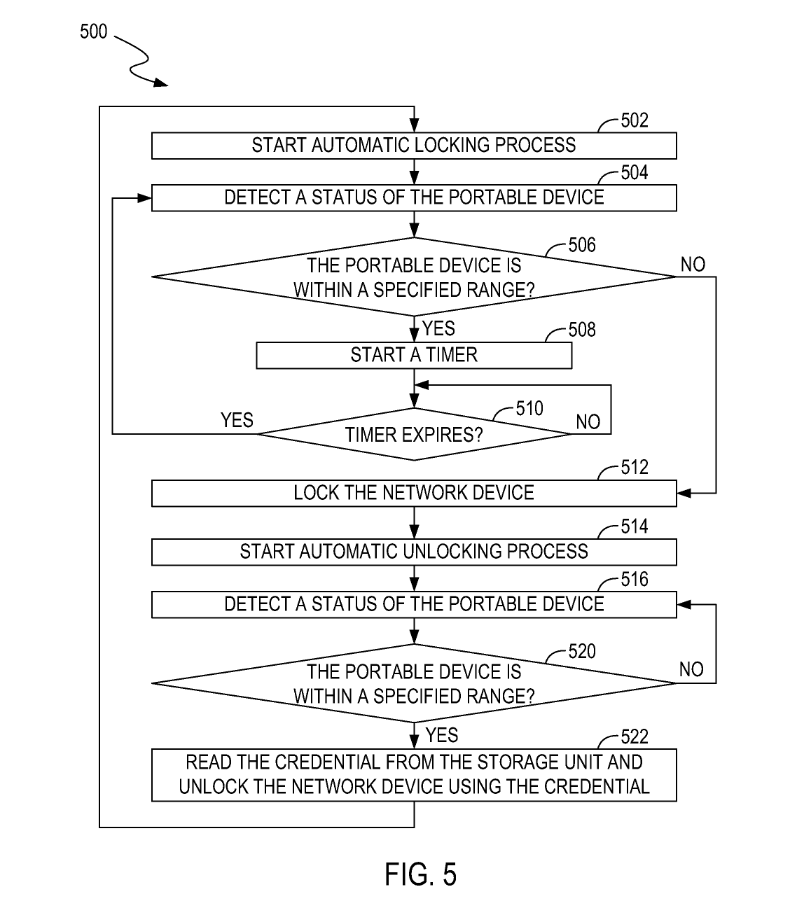

FIG. 5 illustrates a flowchart 500 of an example of an automatic locking/unlocking process performed by the network device 110, in accordance with one embodiment of the present invention. In one embodiment, the flowchart 500 is implemented as computer-executable instructions stored in a non-transitory computer-readable medium. FIG. 5 is described in combination with FIG. 1 and FIG. 3.

In one embodiment, during the time when the portable device 102 is logged on to the network device 110, the network device 110 can perform step 502 to start an automatic locking process. More specifically, at step 504, the detect component 322 detects a status of the portable device 102, e.g., detects whether an IDINF 106 associated with the portable device 102 is received. At step 506, if the portable device 102 is within a specified range around the network device 110, e.g., the detect component 322 receives the IDINF 106 from the portable device 102, the network device 110 performs step 508 to start a timer (not shown in FIG. 1 and FIG. 3). At step 510, if the timer expires, the network device 110 performs step 504 to continue detecting the status of the portable device 102. At step 506, if the portable device 102 is outside the specified range around the network device 110, e.g., the detect component 322 does not receive the IDINF 106 from the portable device 102, the network device 110 performs step 512 to lock the network device 110.

During the time when the network device 110 is locked, the network device 110 can perform step 514 to start an automatic unlocking process. Similarly to step 504, the detect component 322 detects the status of the portable device 102 at step 516. At step 520, in the example of FIG. 5, if the portable device 102 is outside a specified range, the network device 110 performs step 516 to continue attempting to detect the status of the portable device 102. In another embodiment, if the portable device 102 is outside the specified range at step 520, the network device 110 may start a timer and performs step 516 when the timer expires. If the portable device 102 is within the specified range, the flowchart 500 goes to step 522. At step 522, the lock/unlock component 324 reads the credential 120 from the storage unit 316 and unlocks the network device 110 using the credential 120. Following step 522, the flowchart 500 goes to step 502.

In one embodiment, during the detecting process, e.g., at step 504, the portable device 102 can send a data packet that includes the IDINF 106 to the network device 110 periodically, so that the network device 110 remains unlocked. The portable device 102 can also stop sending the data packet to the network device 110 to lock the network device. In another embodiment, the network device 110 can send a request for the IDINF 106 to the portable device 102 periodically. If the portable device 102 is within a specified range, the portable device 102 can, in response to the request, transmit a data packet that includes the IDINF 106 to the network device 110. If the portable device 102 is outside the specified range, the network device 110 may not receive the response from the portable device 102.

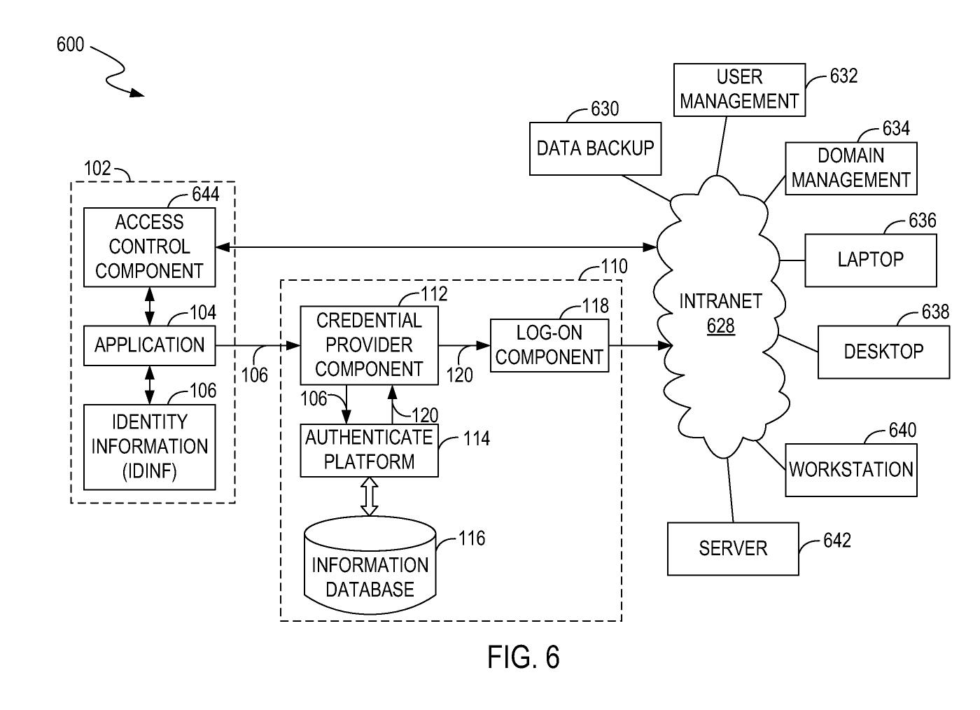

FIG. 6 illustrates a block diagram of an example of a network 600, in accordance with one embodiment of the present invention. Elements that are labeled the same as in FIG. 1 and FIG. 3 have similar functions and will not be described herein. In the example of FIG. 6, the network device 110 can be a router, a gateway, or the like, that connects to an intranet 628. The intranet 628 can be, but is not limited to, an enterprise intranet that includes multiple applications such as data backup 630, user management 632, domain management 634, a laptop 636, a desktop 638, a workstation 640, a server 642, and so on.

In one embodiment, the portable device 102 logs on to the intranet 628 via the network device 110. For example, the network device 110 receives the IDINF 106 of the portable device 102 and authenticates the IDINF 106. If the IDINF 106 is valid, the credential provider component 112 reads a credential 120 associated with the IDINF 106 from the information database 116 and transfers the credential 120 to the log-on component 118. Thus, the log-on component 118 can assist the portable device 102 in logging on to the intranet 628, e.g., logging on to the network device 110, using the credential 120. In one embodiment, the portable device 102 may not be able to access the intranet 628 without logging on to the network device 110.

As shown in FIG. 6, the portable device 102 may further include an access control component 644 for controlling access to an application, e.g., data backup 630, user management 632, domain management 634, a laptop 636, a desktop 638, a workstation 640, a server 642, etc., of the intranet 628. When the portable device 102 logs on to the network device 110 successfully, the portable device 102 can access the application of the intranet 628 using the access control component 644.

The portable device 102 may download the access control component 644 from the network device 110, e.g., when the portable device 102 logs on to the network device 110 successfully at the first time. The portable device 102 may also install the access control component 644 using an installation disk. Various methods can be used to install the access control component 644 into the portable device 102.

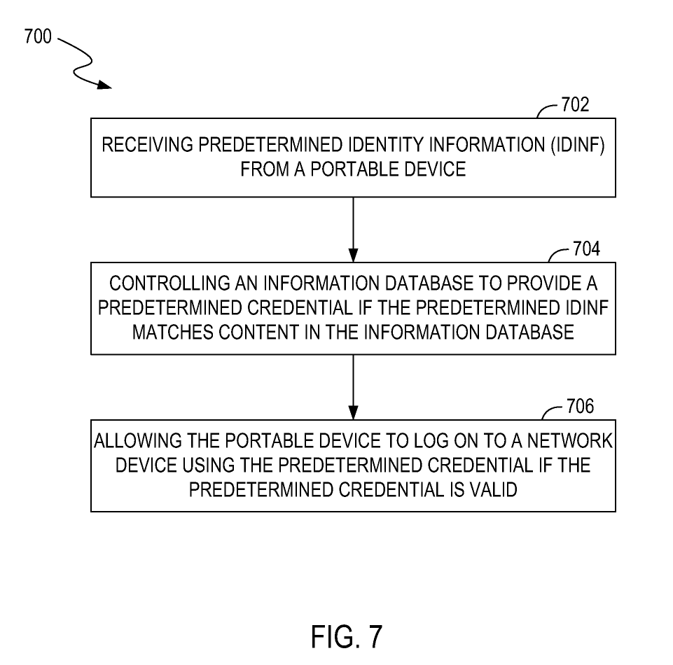

FIG. 7 illustrates a flowchart 700 of examples of operations performed by the network device 110, in accordance with one embodiment of the present invention. FIG. 7 is described in combination with FIG. 1, FIG. 3 and FIG. 6.

At step 702, the credential provider component 112 receives a predetermined IDINF 106 from a portable device 102. The predetermined IDINF 106 can include a serial number and/or an address. More specifically, in one embodiment, the serial number is an IMSI number of an SIM card plugged into the portable device 102. In one embodiment, the address is a network address of a communication module in the portable device 102. For example, the network address is a BLUETOOTH address for a BLUETOOTH communication module. For another example, the network address is a MAC address for a wired communication module or a wireless communication module.

At step 704, the credential provider component 112 controls the information database 116 to provide a predetermined credential 120 to the log-on component 118 if the predetermined IDINF 106 matches content in the information database 116. More specifically, the network device 110 can search for the predetermined IDINF 106 in a set of data pairs stored in the information database 116. If the predetermined IDINF 106 is found in the information database 116, then the predetermined IDINF 106 matches a data pair stored in the information database 116. The data pair also includes a predetermined credential 120 associated with the predetermined IDINF 106.

At step 706, the log-on component 118 allows the portable device 102 to log on to the network device 110 using the predetermined credential 120 if the predetermined credential 120 is valid. The predetermined credential 120 can be selected from the group consisting of: a user name, a password, data representative of characteristics of a face, data representative of characteristics of a fingerprint, and the like associated with a user who owns or is authorized to use the portable device 102.

Embodiments according to the present invention provide network devices that include log-on interfaces and/or unlock interfaces. The network device can use a credential associated with a user to log on to or unlock the network device automatically. For example, the credential can be associated with secure information (an IDINF) of the portable device, e.g., by pairing the credential and the IDINF in an information database. The network device can receive the IDINF from the portable device and read the credential associated with the IDINF from the information database. The network device can be used in various applications such as computer systems, routers, gateways, and so on.

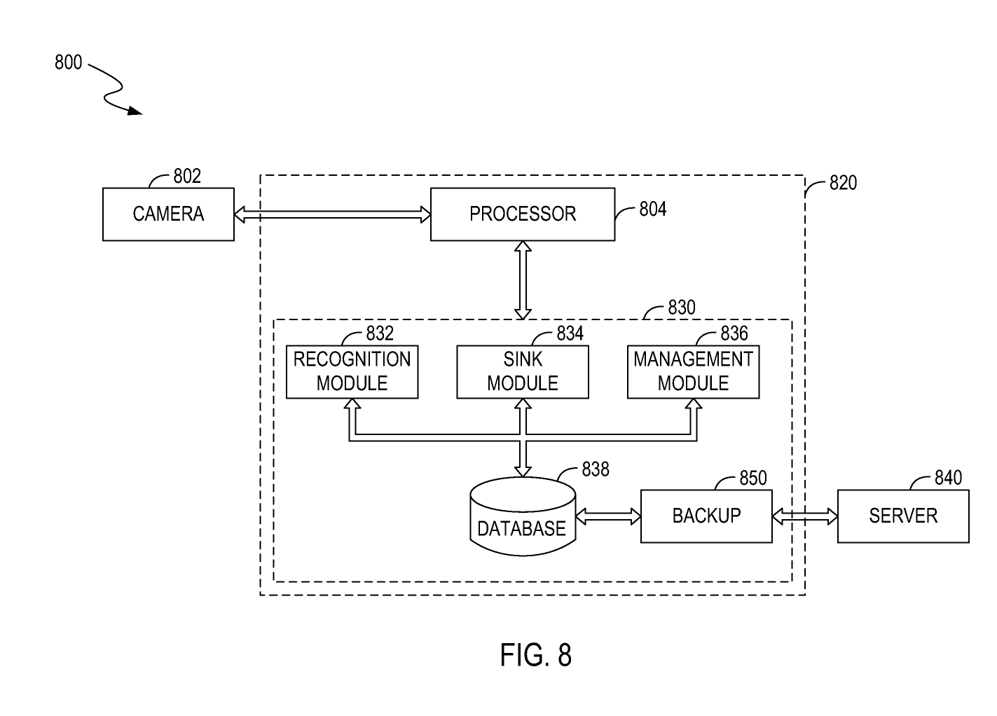

In one embodiment, the network device is a computer system. When the portable device logs on to the computer system successfully, a user can log on to a website through facial authentication. FIG. 8 shows a computer system 800 for enabling website logon through facial authentication, in accordance with one embodiment of the present invention. The computer system 800 can automatically fill in a user's logon identification and password to enable website logon if the user passes the facial authentication. The computer system 800 includes a client 820 and a server 840. The client 820 can be a computer, a personal digital assistant (PDA), or the like. The client includes a processor 804, e.g., a central processing unit (CPU), and a computer-readable medium, e.g., a storage device 830 (e.g., a hard drive). The client 820 is coupled to a camera 802. The camera 802 controlled by the processor 804 is operable for capturing optical images and for generating electrical signals representing the captured images. The processor 804 receives electrical signals representing the captured images from the camera 802 and sends the electrical signals representing the captured images to various modules in the storage device 830. In another embodiment, the camera 802 can be integrated into the client 820.

In one embodiment, the storage device 830 stores a image recognition module 832, a sink module 834, a management module 836, a database 838, and a backup and synchronization module 850. The image recognition module 832 includes computer-executable instructions which can be executed by the processor 804 to perform image recognition, such as facial recognition. The image recognition module 832, executed by the processor 804, compares the captured facial image of a user from the camera 802 to one or more facial templates stored in the database 838. The user passes authentication if the captured facial image of the user matches at least one facial template stored in the database 838. Otherwise, the user does not pass authentication.

The sink module 834 includes computer-executable instructions which can be executed by the processor 804. The sink module 834 can be a web browser sink module that is embedded in a web browser. The sink module 834 including the computer-executable instructions can be executed by the processor 804 to cooperate with the web browser to automatically capture a logon credential including a logon ID and a password entered by a user into a web page. Moreover, the sink module 834 including the computer-executable instructions can be executed by the processor 804 to associate a user's logon credential for a web page with a corresponding image template of the user and to fill in the logon credential in the web page if the user passes authentication, e.g., if the captured facial image matches an image template.

The database 838 can store, for example, facial templates, logon credentials including logon IDs and passwords, and website addresses of the web pages. In one embodiment, if a web page is opened, the processor 804 executes the sink module 834 to capture the web address of the webpage. The processor 804 is also capable of detecting whether the user has passed the authentication. If the processor 804 detects that the electrical signals representing the captured facial image from the camera 802 matches a facial image template stored in the database 838, the processor 804 can execute the sink module 834 to check if a logon credential associated with the web address of the web page and associated with the matched image template is stored in the database 838. If such a logon credential is found in the database 838, the processor 804 can execute the sink module 834 to automatically fill in the corresponding user logon credential in the webpage. As such, the user does not have to input the logon credential manually. Upon successful user authentication, the processor 804 can execute the sink module 834 to automatically fill in the user's logon credential.

The management module 836 including computer-executable instructions can be executed by the processor 804 to display information including, but is not limited to, web addresses and user logon credentials associated with the web addresses respectively. As a result, the user is able to manage the user's logon credentials, e.g., view, edit, add, or delete one or more logon credentials in the database 838.

The backup and synchronization module 850 includes computer-executable instructions executed by the processor 804 to back up data stored in the database 838 to the remote server 840, and synchronize data from the remote server 840 to the database 838. Therefore, when the client 820 is connected to the remote server 840, the data stored in the remote server 840 can be automatically synchronized to the client 820 by the backup and synchronization module 850.

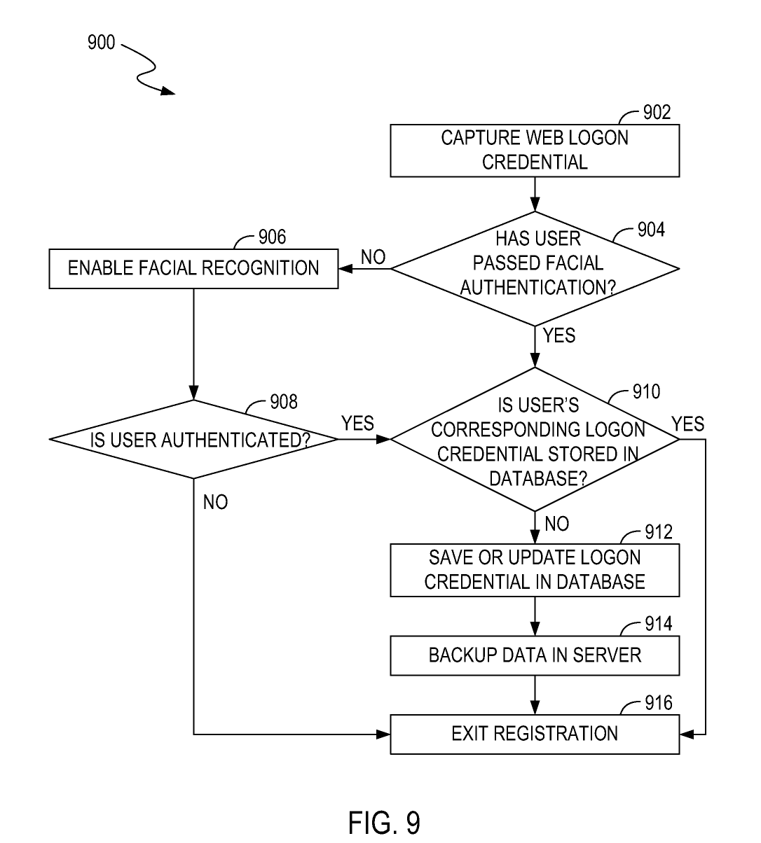

FIG. 9 shows a flowchart 900 of a method for capturing the user logon credential, in accordance with one embodiment of the present invention. Although specific steps are disclosed in FIG. 9, such steps are examples for illustrative purposes. That is, the present invention is well suited to performing various other steps or variations of the steps recited in FIG. 9. In one embodiment, the flowchart 900 is implemented as computer-executable instructions stored in a computer-readable medium. FIG. 9 is described in combination with FIG. 8.

A user U1 may need to register an account to access a web page W1 and may manually input the user logon credential including the user ID and password when logging on to the web page W1 for the first time. In block 902, the logon credential including the user ID and password input by the user U1 is captured. More specifically, the sink module 834 executed by the processor 804 can cooperate with the web browser to automatically capture the logon credential including the user ID and password typed by the user U1 in the web page W1. In block 904, the processor 804 can determine if the user U1 has passed facial authentication. If the user U1 has passed the facial authentication, the flowchart 900 goes to block 910. Otherwise, the flowchart 900 goes to block 906. In block 906, the processor 804 will trigger the recognition module 832 to enable the facial recognition process. The camera 802 can capture one or more facial images of the user U1. In block 908, the processor 804 executes the recognition module 832 to determine if the captured facial image from the camera 802 matches one of the facial image templates stored in the database 838. If the user U1 passes authentication, e.g., the captured facial image matches a facial image template T1 stored in the database 838, the flowchart 900 goes to block 910. Otherwise, the flowchart 900 goes to block 916 to exit the registration.

In block 910, the processor 804 can execute the sink module 834 to determine if the captured logon credential of the user U1 associated with the web page W1 already exists in the database 838. If the corresponding logon credential is already stored in the database 838, the flowchart 900 goes to block 916 to exit the registration process. Otherwise, the processor 804 executes the sink module 834 to save the captured logon credential in the database 838, as described in block 912. Advantageously, the processor 804 can execute the sink module 834 to bundle or associate the user logon credential with the corresponding facial image template T1. As a result, the logon credential is associated with the corresponding web page W1 and the corresponding facial image template T1. In block 914, the data in the database 838 can be backed up in the remote server 840 by the backup and synchronization module 850.

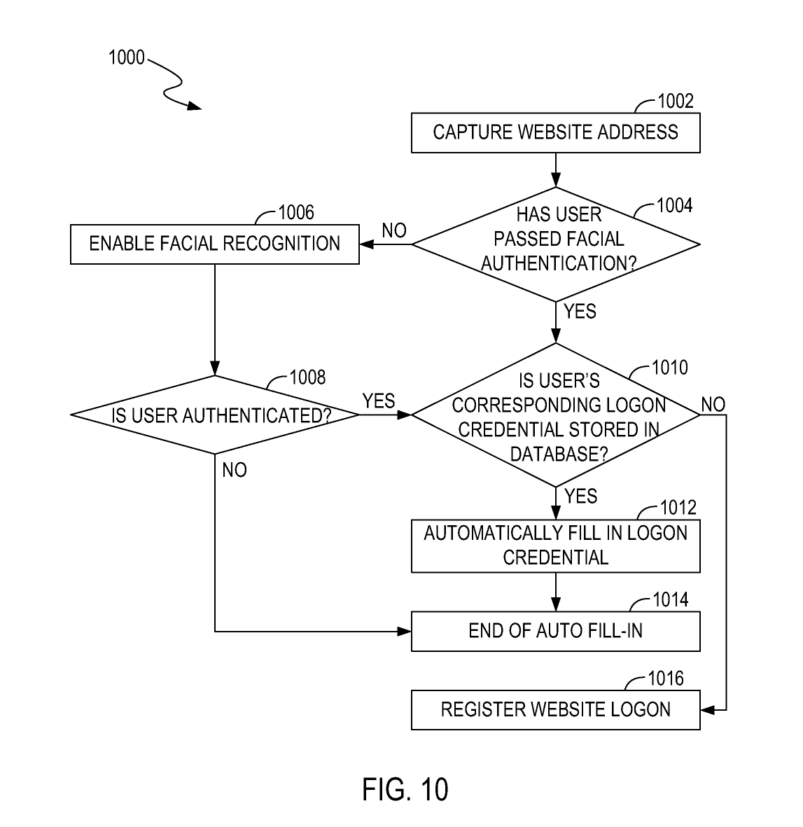

FIG. 10 shows a flowchart 1000 of a method for automatically filling in the user logon credential, in accordance with one embodiment of the present invention. Although specific steps are disclosed in FIG. 10, such steps are examples for illustrative purposes. That is, the present invention is well suited to performing various other steps or variations of the steps recited in FIG. 10. In one embodiment, the flowchart 1000 is implemented as computer-executable instructions stored in a computer-readable medium. FIG. 10 is described in combination with FIG. 8 and FIG. 9.

In block 1002, when a web page is opened, the processor 804 can execute the sink module 834 to capture the website address of the web page. In block 1004, the processor 804 can determine if the user U1 has passed the authentication. If the user U1 has passed the facial authentication, the flowchart 1000 goes to block 1010. Otherwise, the flowchart 1000 goes to block 1006. In block 1006, the processor 804 will trigger the recognition module 832 to enable the facial recognition. The camera 802 can capture one or more facial images of the user U1. In block 1008, the processor 804 executes the recognition module 832 to determine if the captured facial image from the camera 802 matches one of the facial image templates stored in the database 838. If the user U1 passes authentication, e.g., the captured facial image matches a facial image template T1 stored in the database 838, the flowchart 1000 goes to block 1010. Otherwise, the flowchart 1000 goes to block 1014 to exit the automatic fill-in process.

In block 1010, the processor 804 can execute the sink module 834 to determine if a corresponding logon credential of the user U1 associated with the web page W1 and the facial image template T1 exists in the database 838. If the corresponding logon credential is not found in the database 838, the flowchart 1000 goes to block 1016 to go to the registration process in the flowchart 900 in FIG. 9. Otherwise, the processor 804 executes the sink module 834 to automatically fill in the logon credential in the web page W1, as described in block 1012. Thus, the user does not have to manually input the logon credential. In block 1014, the flowchart 1000 exits the automatic fill-in process.

Although the invention is described under the context of web pages, the invention is not so limited. For example, the invention can be used to automatically fill in logon credentials of other types of software, e.g., instant messengers, that requires access by a user ID and a password.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A non-transitory computer-readable storage medium having computer-executable components stored thereon, said computer-executable components comprising:
a credential provider component for receiving predetermined identity information (IDINF) from a portable device and controlling an information database to provide a predetermined credential if said predetermined IDINF matches content in said information database; and
a log-on component for allowing said portable device to log on to a network device using said predetermined credential if said predetermined credential is valid.

2. The non-transitory computer-readable storage medium as claimed in claim 1, wherein an operation performed by said log-on component is supported by an operating system in said network device.

3. The non-transitory computer-readable storage medium as claimed in claim 1, wherein said computer-executable components further comprise a detect component to detect a status of said portable device and generate a signal to lock said network device if said status indicates that said portable device is outside a specified range.

4. The non-transitory computer-readable storage medium as claimed in claim 3, wherein said detect component generates a signal to unlock said network device using said predetermined credential if said status indicates that said portable device is within said specified range.

5. The non-transitory computer-readable storage medium as claimed in claim 3, wherein said detect component detects said status of said portable device by detecting whether said network device receives said predetermined IDINF.

6. The non-transitory computer-readable storage medium as claimed in claim 1, wherein said computer-executable components further comprise an access control component for controlling access of said portable device to an intranet.

7. The non-transitory computer-readable storage medium as claimed in claim 1, wherein said predetermined credential is selected from the group consisting of: a user name, a password, data representative of characteristics of a face, and data representative of characteristics of a fingerprint.

8. The non-transitory computer-readable storage medium as claimed in claim 1, wherein said predetermined IDINF comprises an international mobile subscriber identity (IMSI) number.

9. The non-transitory computer-readable storage medium as claimed in claim 1, wherein said predetermined IDINF comprises an address selected from the group consisting of: a BLUETOOTH address and a media access control (MAC) address.

10. The computer-readable storage medium as claimed in claim 1, wherein if said predetermined IDINF is found in said information database, then said predetermined IDINF matches said content in said information database.

11. A computer-implemented method comprising:
receiving predetermined identity information (IDINF) from a portable device;
controlling an information database to provide a predetermined credential if said predetermined IDINF matches content in said information database; and
allowing said portable device to log on to a network device using said predetermined credential if said predetermined credential is valid.

12. The computer-implemented method as claimed in claim 11, further comprising:
detecting a status of said portable device; and
locking said network device if said status indicates that said portable device is outside a specified range.

13. The computer-implemented method as claimed in claim 12, further comprising:
unlocking said network device using said predetermined credential if said status indicates that said portable device is within said specified range.

14. The computer-implemented method as claimed in claim 12, further comprising:
detecting whether said network device receives said predetermined IDINF to determine said status of said portable device.

15. The computer-implemented method as claimed in claim 11, further comprising:
providing said portable device with access to an application in an intranet using an access control component.

16. The computer-implemented method as claimed in claim 11, wherein said predetermined credential is selected from the group consisting of: a user name, a password, data representative of characteristics of a face, and data representative of characteristics of a fingerprint.

17. The computer-implemented method as claimed in claim 11, wherein said predetermined IDINF comprises an international mobile subscriber identity (IMSI) number.

18. The computer-implemented method as claimed in claim 11, wherein said predetermined IDINF comprises an address selected from the group consisting of: a BLUETOOTH address and a media access control (MAC) address.

19. The computer-implemented method as claimed in claim 11, further comprising:
searching for said predetermined IDINF in said information database, wherein if said predetermined IDINF is found in said information database, then said predetermined IDINF matches said content in said information database.

20. A network device comprising:
an interface for receiving predetermined identity information (IDINF) from a portable device;
a processor coupled to said interface and operable for authenticating said predetermined IDINF, obtaining a predetermined credential from an information database if said predetermined IDINF matches content in said information database, and allowing said portable device to log on to said network device using said predetermined credential if said predetermined credential is valid.

21. The network device as claimed in claim 20, wherein said processor detects a status of said portable device and locks said network device if said status indicates that said portable device is outside a specified range.

22. The network device as claimed in claim 20, wherein said predetermined credential is selected from the group consisting of: a user name, a password, data representative of characteristics of a face, and data representative of characteristics of a fingerprint.

23. The network device as claimed in claim 20, wherein said predetermined IDINF comprises an international mobile subscriber identity (IMSI) number.

24. The network device as claimed in claim 20, wherein said predetermined IDINF comprises an address selected from the group consisting of: a BLUETOOTH address and a media access control (MAC) address.

25. The network device as claimed in claim 20, wherein if said predetermined IDINF is found in said information database, then said predetermined IDINF matches said content in said information database.
